(19) United States
(12) Patent Application Publication
(10) Pub. No.: US 2003/0093909 A1
(43) Pub. Date: May 22, 2003

(54) Level having a detachable and quick release structure

(76) Inventor: Wen Hsin Liao, Taichung (TW)

Correspondence Address: Wen Hsin Liao, No. 108-24, Chong Chin Road, Ben Tun Chu, Taichung, 406, TW

(21) Appl. No.: 09/988,431

(22) Filed: Nov. 20, 2001

(51) Int. Cl. G01C 9/00

(52) U.S. Cl. 33/375

(57) ABSTRACT

A level includes a level vial device detachably secured to a casing without additional fasteners or tools. The casing has a hook engaged with one end of the level vial device and a spring biased latch for detachably latching the level vial device to the casing. A spring member may be used for biasing the level vial device away from the casing and for allowing the level vial device to be easily disengaged from the casing when the level vial device is released by the latch. The casing has two fences for vertically securing the level vial device to the casing.

### BACKGROUND OF THE INVENTION

1. Field of the Invention

The present invention relates to a level, and more particularly to a level having a detachable and quick release structure.

2. Description of the Prior Art

Various kinds of typical levels have been developed and used today. U.S. Pat. No. 5,111,369 to Shirai et al., discloses one of the typical levels including a bubble vial attached or secured into a vehicle headlight with a casing and a lid, and with a number of bolts which should be threaded to the casing and the lid and the vehicle headlight for securing the members together. The bubble vial may not be easily detached or disengaged from the vehicle headlight.

The present invention has arisen to mitigate and/or obviate the afore-described disadvantages of the conventional levels.

### SUMMARY OF THE INVENTION

The primary objective of the present invention is to provide a level including a detachable and quick release structure.

In accordance with one aspect of the invention, there is provided a level comprising a casing, a level vial device, means for detachably securing the level vial device to the casing without additional fasteners or tools, and means for biasing the level vial device away from the casing when the level vial device is released by the detachably securing means, for allowing the level vial device to be easily disengaged from the casing.

The level vial device includes a first end and a second end, the detachably securing means includes a hook provided on the casing for engaging with the first end of the level vial device, and a spring biased tongue provided no the casing for detachably engaging with the second end of the level vial device.

The casing includes a spring blade extended therefrom and having the tongue provided on the spring blade. The spring blade includes a knob provided thereon for disengaging the tongue from the level vial device.

The casing includes a chamber formed therein for receiving the level vial device. The casing includes a bottom portion, the biasing means includes a spring blade provided in the bottom portion of the casing and having a finger engaged with the level vial device for applying a spring biasing force against the level vial device.

The bottom portion of the casing includes an orifice formed therein for receiving the spring blade, the spring blade includes a first end attached to the casing and a second end having the finger provided thereon.

The second end of the spring blade includes a downwardly extended hub having the finger extended upward therefrom.

The casing includes means for vertically attaching the level vial device to the casing. The level vial device includes a first end and a second end, the attaching means includes a channel formed in the casing for receiving the first end of the level vial device.

The casing includes a pair of fences for defining the channel therebetween and for engaging with the first end of the level vial device.

The first end of the level vial device includes at least one groove formed therein, the fences include at least one guide rib extended therefrom and engageable into the groove of the level vial device for detachably securing the first end of the level vial device to the casing.

A plate is further provided and includes an opening formed therein for receiving the casing and includes an upper portion and a lower portion, A fastening device includes a panel and an ear extended from the casing and engaged onto the upper and the lower portions of the plate respectively for detachably securing the casing to the plate.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a level in accordance with the present invention;

FIG. 2 is an enlarged partial perspective view of the level;

FIG. 3 is a partial exploded view of the level;

FIG. 4 is a partial cross sectional view taken along lines 4-4 of FIG. 2;

FIG. 5 is a partial cross sectional view similar to FIG. 4, illustrating the detailed structure of the level;

FIG. 6 is an enlarged partial perspective view similar to FIG. 2, illustrating the operation of the level; and

FIG. 7 is a cross sectional view taken along lines 7-7 of FIG. 6.

### DETAILED DESCRIPTION OF THE PREFERRED EMBODIMENT

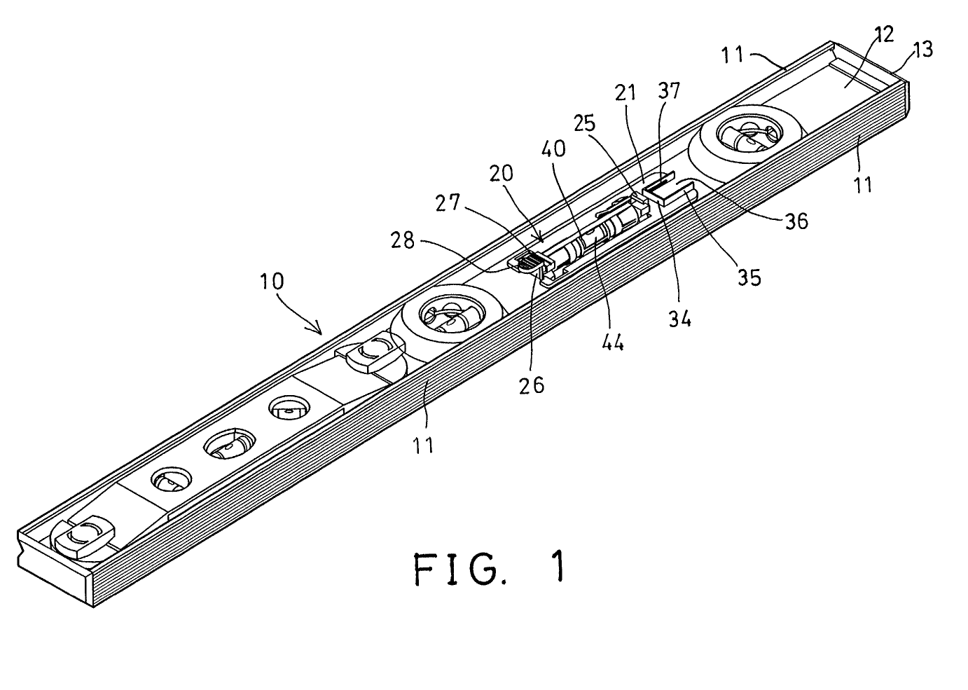

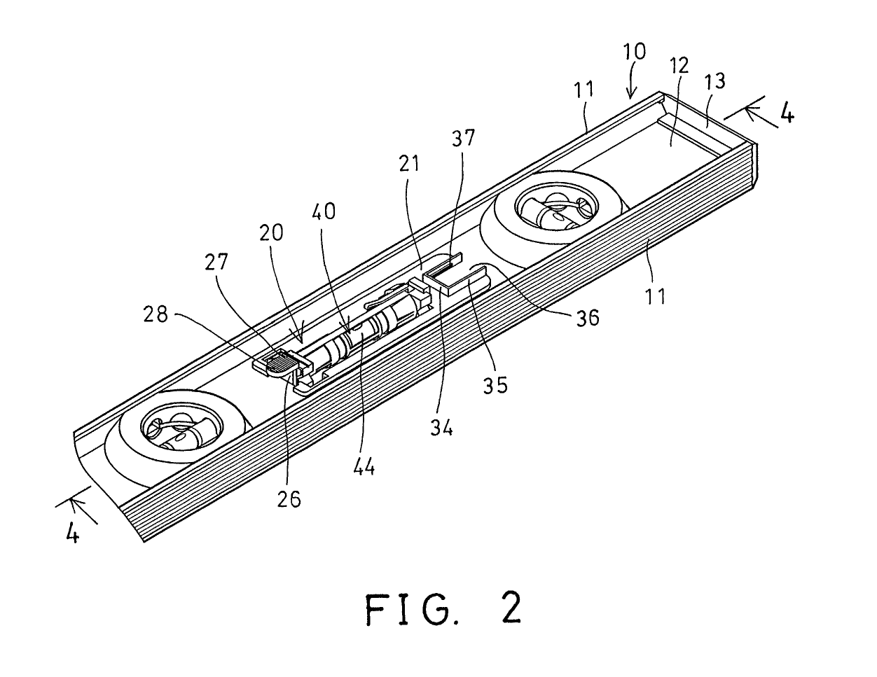

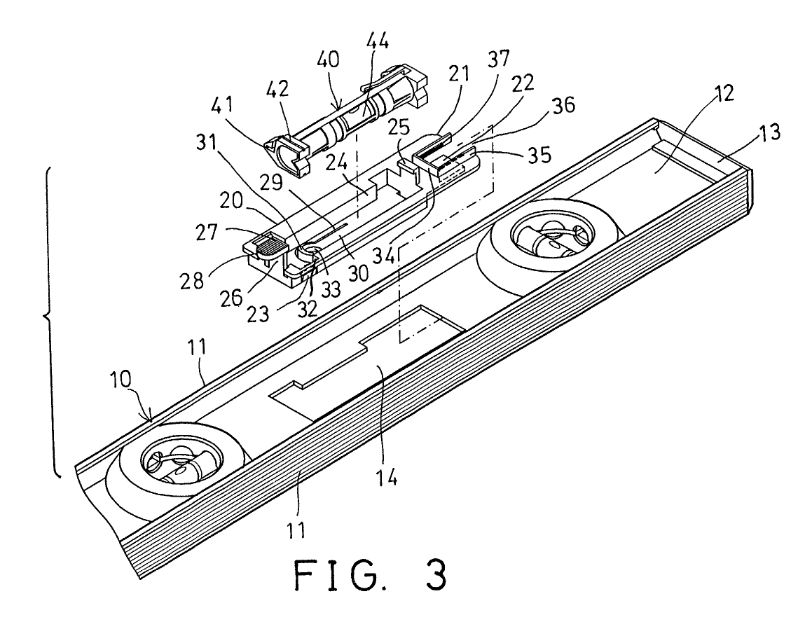

Referring to the drawings, and initially to FIGS. 1-5, a level in accordance with the present invention comprises a housing 10 including a pair of side walls 11, a plate 12 provided or extended or disposed or secured between the middle portions of the side walls 11, and two end walls 13 secured to the ends of the side walls 11 and the plate 12. The housing 10 includes one or more openings 14 formed therein. However, only one of the openings 14 is shown in the plate 12 of the housing 10, as shown in FIGS. 3-5.

A casing 20 is partially engaged into the opening 14 of the housing 10, and includes a panel 21 having a width or a length or an area greater than the corresponding width or length or area of the opening 14 of the housing 10, for allowing the panel 21 to be engaged with and attached onto the upper portion of the plate 12. The casing 20 includes one end having an ear 22 extended therefrom and located below or spaced from the panel 21 allowing the panel 21 to be engaged with the bottom portion of the plate 12, best shown in FIGS. 3-5, and for allowing the one end of the casing 20 to be secured onto the plate 12, without fasteners. The casing 20 includes one or more spring-biased catches 23 (FIG. 3) provided on the other end thereof for engaging with the plate 12 and for detachably securing to the plate 12 without fasteners. The spring-biased catches 23 may be depressed inward of the casing 20 for allowing the casing 20 to be disengaged from the plate 12.

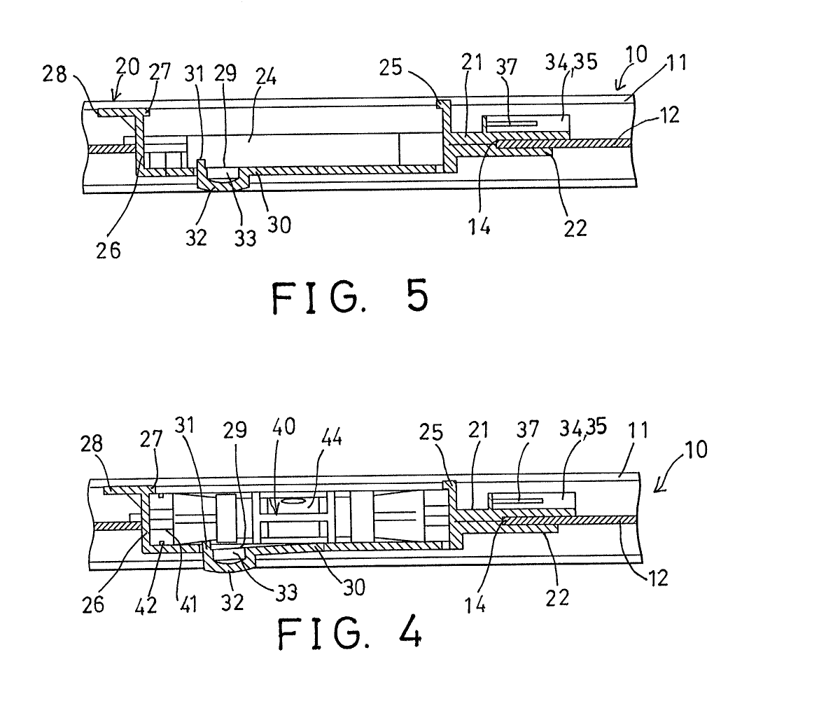

The casing 20 includes a chamber 24 formed therein for receiving a level vial device 40 therein which includes two end blocks 41 and one or more bubble vials 44 received or engaged therein. The casing 20 includes a hook 25 provided on the middle or the end portion thereof, such as located close to the ear, for hooking or engaging with and for securing one of the end blocks 41 of the level vial device 40 to the casing 20. The casing 20 includes a spring-biased latch provided on the other end and having a spring blade 26 extended from the other end of the casing 20 and having a tongue 27 for being biased to engage with and to secure the other end or the other end block 41 of the level vial device 40 to the casing 20 (FIG. 4). The spring biased latch includes a hand grip or a knob 28 extended from the tongue 27 for disengaging the tongue 27 from the level vial device 40 and for detachably securing the level vial device 40 to the casing 20 without additional fasteners and tools.

The casing 20 includes an orifice 29 formed in the bottom portion thereof and communicating with the chamber 24 thereof, and includes another spring blade 30 extended in the orifice 29 of the casing 20 and having one end secured to or formed integral with the casing 20. The spring blade 30 includes a free end having a finger 31 extended inward of the chamber 24 of the casing 20 (FIG. 5) for engaging with and for applying a spring biasing force against the level vial device 40 (FIG. 4) and for spring or biasing one end of the level vial device 40 outward of the casing 20 when the tongue 27 of the spring biased latch is disengaged from the one end of the level vial device 40, and for allowing the level vial device 40 to be easily disengaged from the casing 20.

The spring blade 30 preferably includes a downward extending hub 32 having a cavity 33 formed therein and having the finger 31 extended upward therefrom, for allowing only the finger 31 to engage with the level vial device 40, and for decreasing the contact area between the level vial device 40 and the spring blade 30. The level vial device 40 may thus be easily and quickly engaged into and disengaged from the casing 20 without additional fasteners and tools.

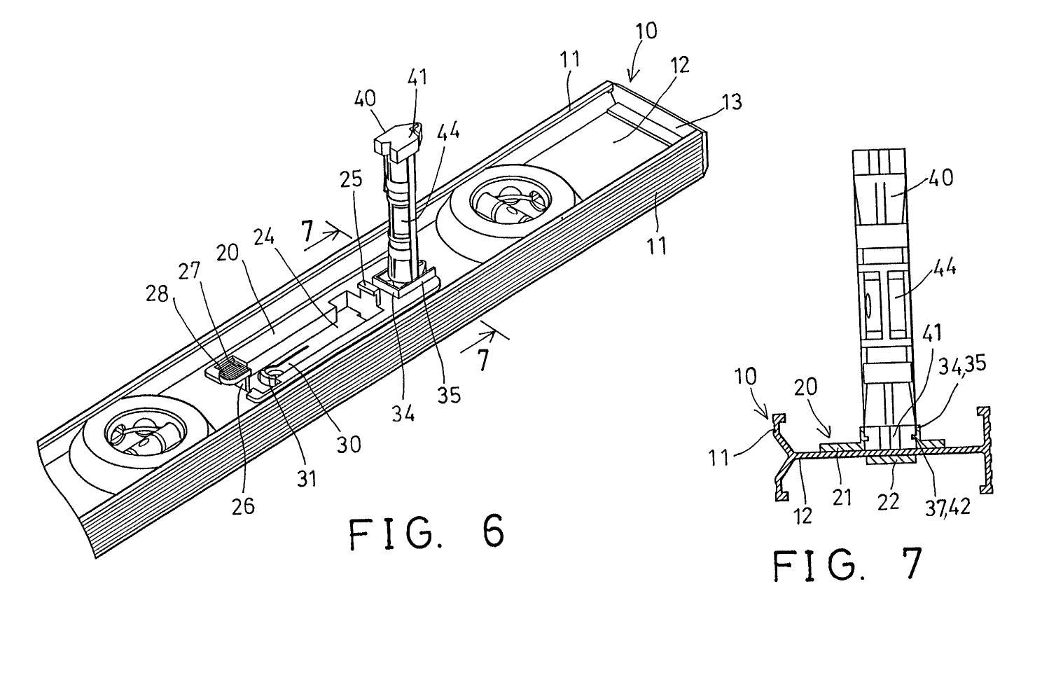

Referring next to FIGS. 6 and 7, and again to FIGS. 1-3, the casing 20 includes a frame 34 formed or provided on one end thereof and having two side fences 35 and a channel 36 formed or defined between the side fences 35 for slidably receiving the end blocks 41 of the level vial device 40 (FIGS. 6, 7). One or both of the side fences 35 each includes a guide rib 37 extended therefrom, such as extended inward of the channel 36 thereof. The level vial device 40 includes one or more end blocks 41 each having one or more grooves 42 formed in the side portion thereof for receiving the guide ribs 37 (FIG. 7) and for allowing the level vial device 40 to be vertically secured to the casing 20 by such as a force-fitted engagement.

In operation, as shown in FIG. 4, the level vial device 40 may be engaged into the chamber 24 of the casing 20, and may have one of the end blocks 41 engaged with the hook 25, and the other end block 41 engaged with the spring biased tongue 27, such that the level vial device 40 may thus be easily and quickly engaged into and disengaged from the casing 20 without additional fasteners and tools. After the level vial device 40 has been disengaged from the casing 20, one of the end blocks 41 may be engaged into the channel 36 of the casing 20 and may have the guide ribs 37 engaged into the grooves 42 of the end block 41, for detachably and vertically securing the level vial device 40 onto the casing 20.

Accordingly, the level in accordance with the present invention includes a detachable and quick release structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A level comprising:
a casing,
a level vial device,
means for detachably securing said level vial device to said casing, and
means for biasing said level vial device away from said casing when said level vial device is released by said detachably securing means.

2. The level according to claim 1, wherein said level vial device includes a first end and a second end, said detachably securing means includes a hook provided on said casing for engaging with said first end of said level vial device, and a spring biased tongue provided no said casing for detachably engaging with said second end of said level vial device.

3. The level according to claim 2, wherein said casing includes a spring blade extended therefrom and having said tongue provided on said spring blade.

4. The level according to claim 3, wherein said spring blade includes a knob provided thereon for disengaging said tongue from said level vial device.

5. The level according to claim 1, wherein said casing includes a chamber formed therein for receiving said level vial device.

6. The level according to claim 1, wherein said casing includes a bottom portion, said biasing means includes a spring blade provided in said bottom portion of said casing and having a finger engaged with said level vial device for applying a spring biasing force against said level vial device.

7. The level according to claim 6, wherein said bottom portion of said casing includes an orifice formed therein for receiving said spring blade, said spring blade includes a first end attached to said casing and a second end having said finger provided thereon.

8. The level according to claim 7, wherein said second end of said spring blade includes a downwardly extended hub having said finger extended upward therefrom.

9. The level according to claim 1, wherein said casing includes means for vertically attaching said level vial device to said casing.

10. The level according to claim 9, wherein said level vial device includes a first end and a second end, said attaching means includes a channel formed in said casing for receiving said first end of said level vial device.

11. The level according to claim 10, wherein said casing includes a pair of fences for defining said channel therebetween and for engaging with said first end of said level vial device.

12. The level according to claim 11, wherein said first end of said level vial device includes at least one groove formed therein, said fences include at least one guide rib extended therefrom and engageable into said at least one groove of said level vial device for detachably securing said first end of said level vial device to said casing.

13. The level according to claim 1 further comprising a plate, and means for fastening said casing to said plate.

14. The level according to claim 13, wherein said plate includes an opening formed therein for receiving said casing and includes an upper portion and a lower portion, said fastening means includes a panel and an ear extended from said casing and engaged onto said upper and said lower portions of said plate respectively for detachably securing said casing to said plate.
